(19) United States
(12) Patent Application Publication
(10) Pub. No.: US 2026/0208292 A1
(43) Pub. Date: Jul. 23, 2026

(54) GAS ASSISTED BURR REMOVAL

(71) Applicant: GM Global Technology Operations LLC, Detroit, MI (US)

(72) Inventors: Abigail Lukas, Troy, MI (US); Karis Wentz, Ferndale, MI (US); Raghavendra Saikrishna Keerthi Manda, Northville, MI (US); Tyson Whittier Brown, Royal Oak, MI (US); Kyle W. Pfahl, Macomb, MI (US)

(21) Appl. No.: 19/033,680

(22) Filed: Jan. 22, 2025

(51) Int. Cl. B23K 26/14; B23K 26/12; B23K 26/361; H01M 4/04

(52) U.S. Cl. CPC B23K 26/1462; B23K 26/1224; B23K 26/361; H01M 4/04

(57) ABSTRACT

A system performs a method of manufacturing an electrode of a battery cell. An edge of the electrode including an artifact at a selected location is radiated with a cleaning laser. A first support structure supports the electrode and a second support structure supports the cleaning laser. A relative movement is created between the electrode and the cleaning laser via the first support structure and the second support structure to align the selected location with a nozzle located at a distance from the cleaning laser. A first stream of gas is blown across a first surface of the electrode from the nozzle to remove the artifact from the edge. The artifact is received in a second chamber via a vacuum between the first chamber and the second chamber.

The subject disclosure relates to vehicles, and in particular to a system and method for removing burrs from an electrode.

The process of creating a battery pack for use in an electric vehicle often includes cutting an electrode using a laser. Laser cutting can create various artifacts, such as burrs on the tabs and shoulder of the electrodes. When the electrode is assembled into a battery cell of the battery pack, the shoulders are in a position to come in contact with a separator of the battery cells and thus a burr can pierce the separator, thereby creating conditions for a malfunction of the battery cell. Accordingly, it is desirable to provide a system and method for removing a burr from an electrode during a manufacturing stage.

### SUMMARY

In one exemplary embodiment, a method of manufacturing an electrode of a battery cell is disclosed. An edge of the electrode including an artifact at a selected location is radiated with a cleaning laser to radiate the artifact with a beam of light, wherein a first support structure supports the electrode within a first chamber and a second support structure supports the cleaning laser. A relative movement is created between the electrode and the cleaning laser via the first support structure and the second support structure to align the selected location with a nozzle located at a distance from the cleaning laser. A first stream of gas is blown across a first surface of the electrode from the nozzle to remove the artifact from the edge. The artifact is received in a second chamber via a vacuum between the first chamber and the second chamber.

In addition to one or more of the features described herein, wherein the second support structure includes the cleaning laser and a bristled device and the nozzle includes a plurality of nozzles that are spaced apart along the electrode in a direction of a first path, the method further includes moving the cleaning laser and the bristled device along the first path while maintaining the electrode and the plurality of nozzles in a stationary position.

In addition to one or more of the features described herein, wherein the second support structure includes the cleaning laser and the nozzle, the method further includes moving the cleaning laser and the nozzle while maintaining the electrode in a stationary position.

In addition to one or more of the features described herein, the second support structure further includes a bristled device.

In addition to one or more of the features described herein, the method further includes moving the electrode via the first support structure, wherein the second support structure is held in a stationary position and includes the cleaning laser, a bristled device and the nozzle.

In addition to one or more of the features described herein, the nozzle further includes a first nozzle directed along the first surface of the electrode and a second nozzle directed along a second surface of the electrode opposite the first surface.

In addition to one or more of the features described herein, the method further one of blowing the first stream from the nozzle parallel to the first surface, blowing the first stream from the nozzle at an angle of less than 10 degrees to the first surface, blowing the first stream from the nozzle at an angle between 0 degrees and 45 degrees to the first surface, directing a flow of the gas due to the vacuum parallel to the first surface of the electrode, and directing the flow of the gas due to the vacuum perpendicular to the first surface of the electrode.

In addition to one or more of the features described herein, the method further includes creating a vacuum using a plurality of vacuum devices and controlling a balance of pressure between at least two of the plurality of vacuum devices using a check valve.

In another exemplary embodiment, a system for manufacturing an electrode is disclosed. The system includes a first chamber, a second chamber, wherein the second chamber creates a vacuum, a baffle separating the first chamber from the second chamber, the baffle including a slit, a first support structure that maintains the electrode at the slit, wherein the electrode includes an edge having an artifact, a cleaning laser configured to radiate at the edge of the electrode to remove the artifact from the edge of the electrode, a second support structure that supports the cleaning laser, wherein the first support structure and the second support structure generate a relative movement between the electrode and the cleaning laser, and a nozzle directed at a first surface of the electrode for blowing a first stream of gas across the electrode to remove the artifact from the electrode, wherein the artifact is removed to the second chamber via the vacuum.

In addition to one or more of the features described herein, the second support structure includes the cleaning laser and a bristled device and is configured to move the cleaning laser and the bristled device along a first path and the nozzle includes a plurality of nozzles spaced apart along the electrode in a direction of the first path and the electrode and the plurality of nozzles are held in a stationary position.

In addition to one or more of the features described herein, the second support structure includes the cleaning laser and the nozzle and is configured to move the cleaning laser and the nozzle while the electrode is held in a stationary position.

In addition to one or more of the features described herein, the second support structure further includes a bristled device.

In addition to one or more of the features described herein, the first support structure is configured to move the electrode and the second support structure is configured to maintain the cleaning laser, a bristled device and the nozzle in a stationary position.

In addition to one or more of the features described herein, the nozzle further includes a first nozzle directed along the first surface of the electrode and a second nozzle directed along a second surface of the electrode opposite the first surface.

In addition to one or more of the features described herein, one of the nozzle is configured to blow the first stream parallel to the first surface, the nozzle is configured to blow the first stream at an angle of less than 10 degrees to the first surface, the nozzle is configured to blow the first stream at an angle between 0 degrees and 45 degrees to the first surface, the vacuum directs a flow of the gas parallel to the first surface of the electrode, and the vacuum directs the flow of the gas due to the vacuum perpendicular to the first surface of the electrode.

In addition to one or more of the features described herein, the system further includes a plurality of vacuum devices for creating the vacuum and a check valve for controlling a balance of pressure between at least two of the plurality of vacuum devices.

In yet another exemplary embodiment, method of manufacturing an electrode is disclosed. The method includes rolling the electrode over a first roller and a second roller, cleaning an artifact from edge of the electrode using a cleaning laser directed at the electrode at the first roller, and vacuuming the edge of the electrode at the second roller to remove the artifact from the edge of the electrode.

In addition to one or more of the features described herein, the method further includes vacuuming the artifact using vacuum directed radially inward at the second roller.

In addition to one or more of the features described herein, wherein the second roller includes a vacuum section, the method further includes rolling the electrode over the second roller to place the edge at the vacuum section.

In addition to one or more of the features described herein, the method further includes controlling a location of the electrode at the second roller via a tab locator.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an electrode of a battery cell in accordance with an exemplary embodiment;

FIG. 2 shows a side view of a burr removal system used in manufacture of the electrode;

FIG. 3 shows a perspective view of the burr removal system, in an embodiment;

FIG. 4 shows a perspective view of the burr removal system, in another embodiment;

FIG. 5 is a perspective view of the burr removal system. in yet another embodiment;

FIG. 6 depicts a side view of an edge of an electrode, in an illustrative embodiment;

FIG. 7 depicts a side view of the edge at several stages of burr removal;

FIG. 8 shows a burr removal system that can be used to perform the cleaning procedure disclosed herein, in another embodiment; and

FIG. 9 shows a side view of a vacuum roller, in one embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

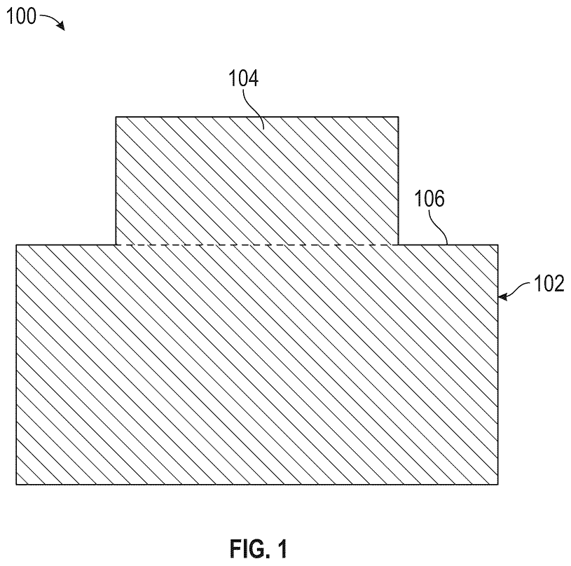

In accordance with an exemplary embodiment, FIG. 1 shows an electrode 100 of a battery cell. The electrode includes an active material 102 with a tab 104 at an end for coupling to other electrical components of the battery cell. The tab 104 is manufactured by cutting the active material 102 of the electrode 100 to form an edge 106. The tab 104 can be cut using various processes, including a laser cutting process, a mechanical notching process, a slitting process, etc. After the cutting process is complete, the tab 104 and the edge 106 can include various artifacts, such as burrs, remelt, dross, spatter, jagged edges, etc., which are located at the edge 106.

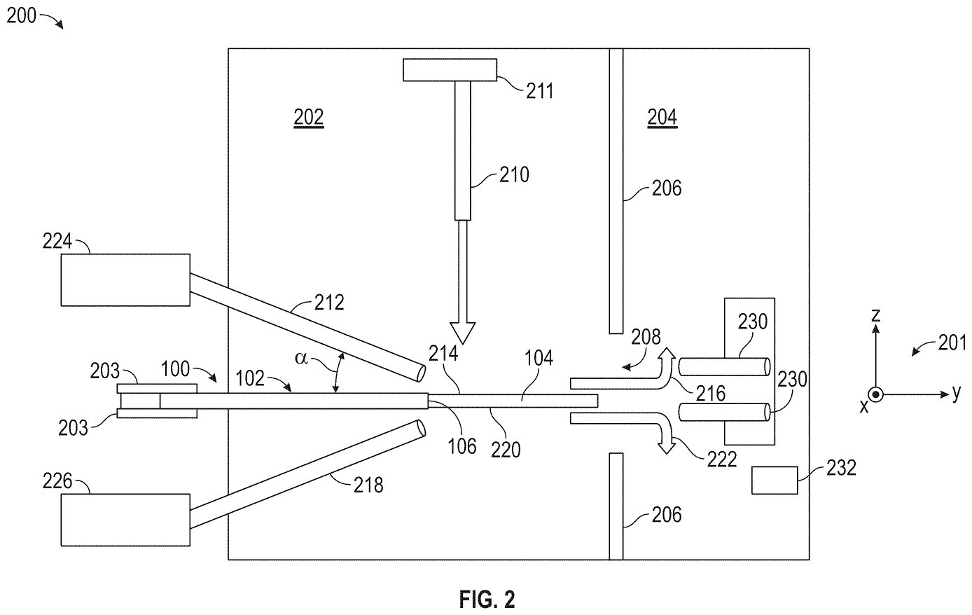

FIG. 2 shows a side view of a burr removal system 200 used in manufacture of the electrode 100. A coordinate system 201 is shown for purposes of explanation. A z-axis of the coordinate system 201 extends in a vertical direction. An x-axis indicates a direction of motion of various components of the burr removal system 200, A y-axis indicates a direction in which air or gas is propelled to extract an artifact or artifacts from the electrode.

The burr removal system 200 includes a first chamber 202 and a second chamber 204. A baffle 206 separates the first chamber 202 from the second chamber 204. The baffle 206 includes a slit 208 that allows air or debris to flow from the first chamber 202 to the second chamber 204. The second chamber 204 has a lower pressure than the first chamber 202, thereby creating a vacuum that moves air through the slit 208. The electrode 100 is disposed in first chamber 202 lying within an xy-plane and at a vertical location of the slit 208. A first support structure 203 supports the electrode and controls movement of the electrode 100. The electrode 100 is oriented with the tab 104 near the slit 208. A cleaning laser 210 is located in the first chamber 202 and is directed at the edge 106 of the electrode 100. A second support structure 211 supports the cleaning laser 210 and controls its movement. The cleaning laser 210 is oriented perpendicular to the electrode 100 and radiates the edge 106 of the electrode 100 with a beam of light.

A first nozzle 212 is located at a first surface 214 of the electrode 100. The first nozzle 212 directs a first stream 216 of gas parallel or substantially parallel (e.g., angle α<10 degrees) to the first surface 214 and toward the slit 208. In various embodiments, the angle can be in a range from 0 degrees (parallel) to 45 degrees to the first surface 214. The first stream 216 of gas acts as an air knife to blow off any debris from the edge 106 of the electrode 100. The first stream 216 can provide a first force component vertically downward on the electrode. A second nozzle 218 is located at a second surface 220 of the electrode 100. The second nozzle 218 directs a second stream 222 of gas parallel or substantially parallel of the second surface 220 and toward the slit 208. The second stream 222 of gas acts as an air knife, similar to the first stream of gas. The second stream 222 also provides a second force component vertically upward on the electrode. The first force component and the second force component balance each other to prevent bending from occurring at the electrode.

The first nozzle 212 can be connected to a first gas supply 224 and the second nozzle 218 can be connected to a second gas supply 226. The air flow of the first nozzle 212 can be controlled independently of the air flow of the second nozzle 218. In one embodiment, the first gas supply 224 and the second gas supply 226 can be the same gas supply.

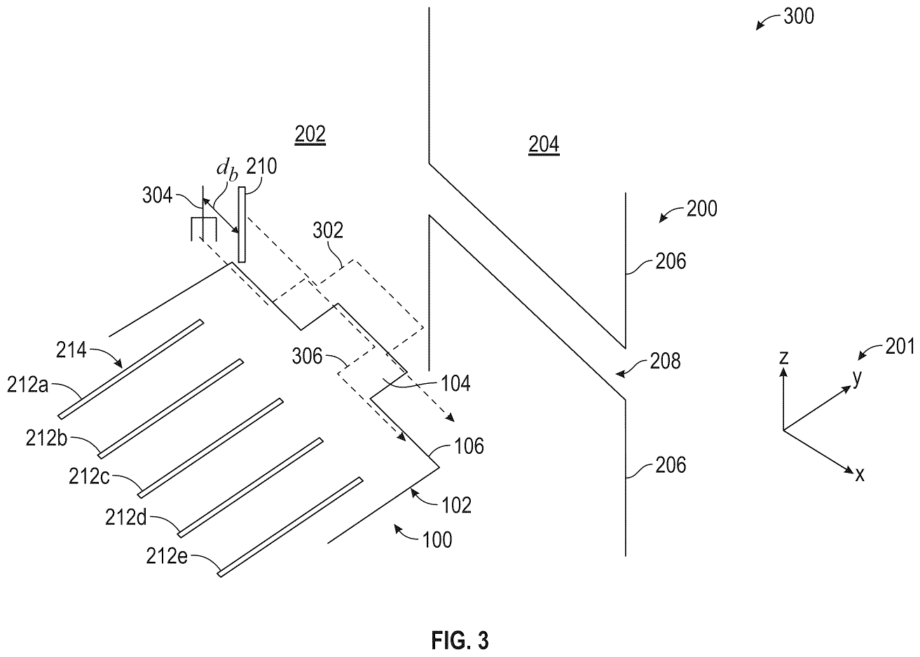

The first support structure 203 and the second support structure 211 can be moved independently of each other to generate a relative movement between the electrode 100 and the cleaning laser 210, the first nozzle 212 (and the second nozzle 218) and a bristled device 304 (FIG. 3) in the various configurations shown herein. In various embodiments, the nozzles and/or the bristled device can be used to clean the electrode with or without use of the cleaning laser 210.

The burr removal system 200 can include a plurality of vacuum devices 230 that direct gas into the second chamber 204. The plurality of vacuum devices 230 can be aligned along the x-axis. A check valve 232 between at least two of the vacuum devices 230 can be operated to control a balance of pressure between the at least two of the vacuum devices. An imbalance of pressure can cause uneven air flow, which can cause damage to the tab(s) of the electrode.

In various embodiments, the first nozzle 212 can direct the stream of gas parallel or perpendicular to the first surface 214. The vacuum can direct a flow of the gas either parallel to the first surface or perpendicular to the first surface.

FIG. 3 shows a perspective view 300 of the burr removal system 200 in an embodiment. The electrode 100 is located at the same vertical (z) location of the slit 208 and moves along the x-axis axis. The first nozzle 212 includes a plurality of first nozzles 212a-212e spaced apart from each other along the x-axis. Although not shown, each of the plurality of first nozzles 212a-212e has a corresponding second nozzle opposite it at the second surface of the electrode 100. The electrode 100 and the plurality of first nozzles 212a-212e are held in a stationary position with respect to the slit 208. The cleaning laser 210 moves in a first path 302 along the x-axis and y-axis to direct its laser beam along the edge 106 of the electrode 100, including the edge 106 of the active material 102 and tab 104. The first path 302 is primarily along the x-axis direction with additional movements along the y-axis when necessary to keep the cleaning laser 210 directed at the edge 106.

The burr removal system 200 can also include a bristled device 304, such as a brush, that is located a distance d_{b} behind the cleaning laser 210. The bristled device 304 moves along a second path 306 that mirrors the first path 302 with a suitable delay that reflects the separation distance d_{b}. The bristled device 304 cleans any debris from the electrode 100 that is left being by the cleaning laser 210.

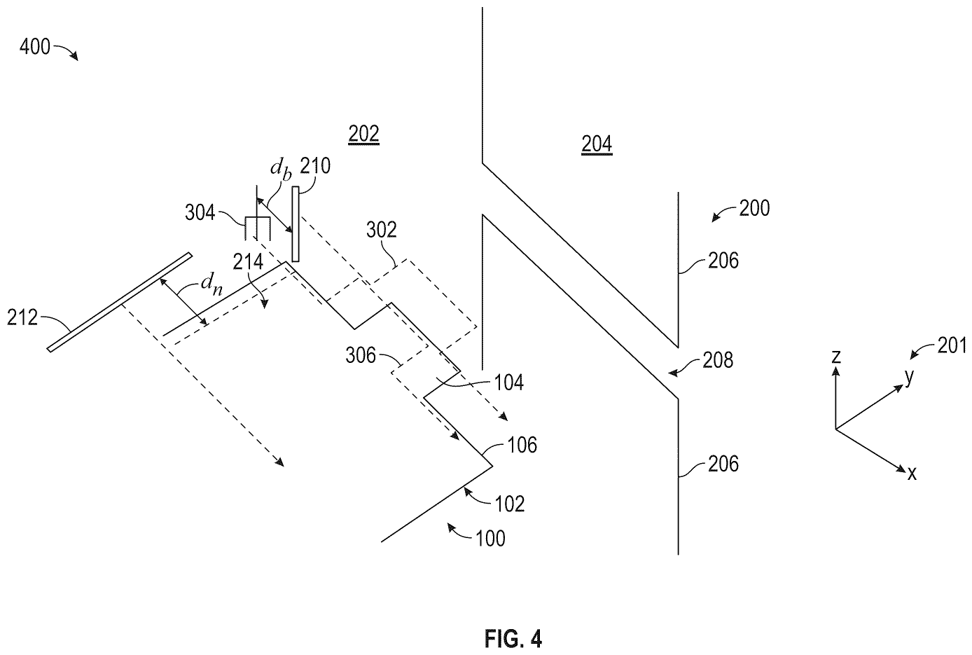

FIG. 4 shows a perspective view 400 of the burr removal system 200 in another embodiment. The electrode 100 is located at the same vertical (z) location of the slit 208 and is held stationary. The cleaning laser 210 moves along the x-axis and y-axis and is controlled to move along a first path 302 the edge 106 of the electrode. The bristled device 304 is located at a first distance d_{b} behind the cleaning laser 210. The first nozzle 212 is located a second distance dₙ behind the cleaning laser. The second distance dₙ is greater than the first distance d_{b} (i.e., dₙ>d_{b}). Thus, the nozzle is further from the cleaning laser 210 (along the x-axis) than the bristled device 304. The first nozzle 212 moves along the x-axis behind the cleaning laser and the bristled device. The bristled device 304 and first nozzle 212 move along a second path 306 that mirrors the first path 302 with suitable delays to clean any debris from the edge 106 after the cleaning laser 210 has passed. Thus, a point on the electrode is first cleaned by the cleaning laser 210, secondly cleaned using the bristled device 304 and thirdly cleaned via the first nozzle 212.

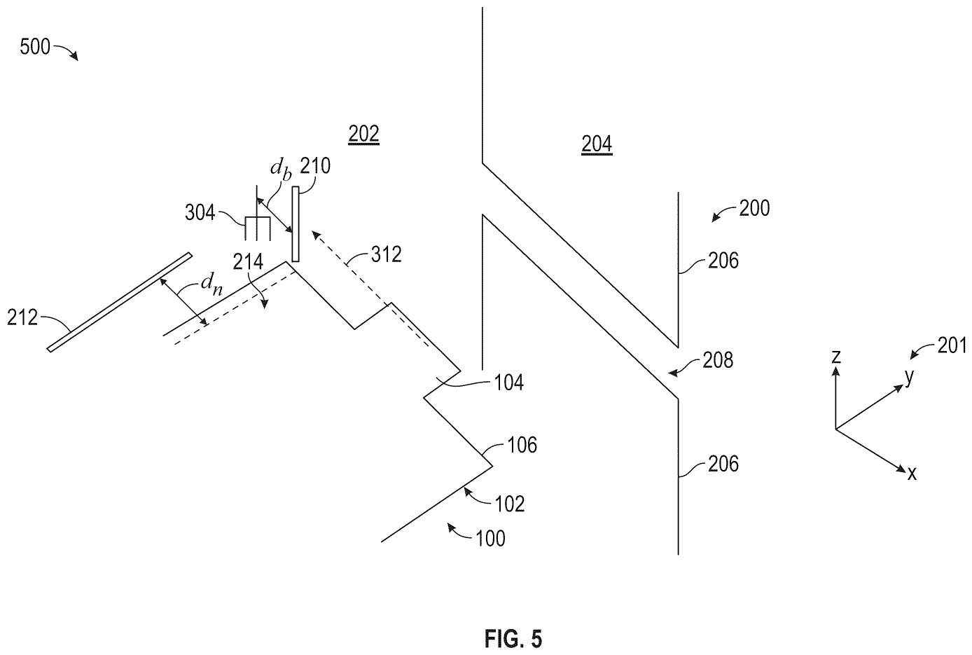

FIG. 5 is a perspective view 500 of the burr removal system 200 in yet another embodiment. The electrode 100 is located at the same vertical (z) location of the slit 208 and moves along the x-axis. The cleaning laser 210, the bristled device 304 and the first nozzle 212 are held in a stationary position with respect to the slit 208. The cleaning laser 210, bristled device 304 and first nozzle 212 have the same configuration as shown in FIG. 4.

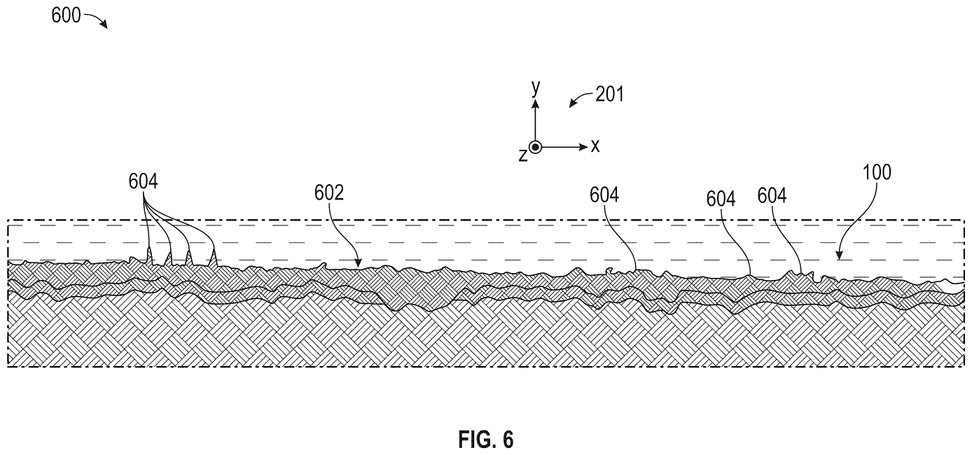

FIG. 6 depicts a side view 600 of an edge 602 of an electrode 100, in an illustrative embodiment. The edge 602 includes a plurality of burrs 604 that are remaining on the edge as a result of cutting the electrode.

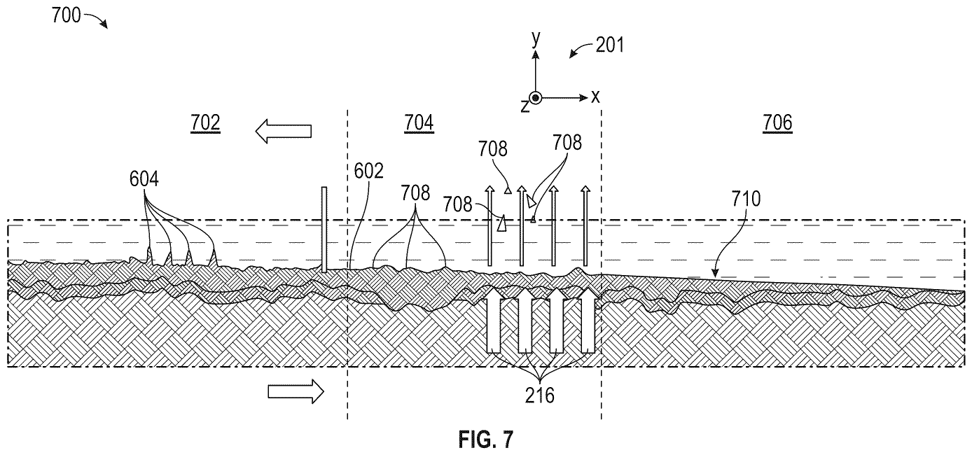

FIG. 7 depicts a side view 700 of the edge 602 at several stages of burr removal. The side view 700 illustrates a first stage 702, a second stage 704 and third stage 706 of burr removal. The first stage 702 is depicted by a section of the edge 602 that has not been cleaned by the cleaning laser. The second stage 704 is depicted by a section of the electrode 100 that has been cleaned by the cleaning laser prior to being cleaned by the air nozzle(s). The third stage 706 is depicted by a section of the electrode after being cleaned by both the cleaning laser and the nozzles. The section representing the first stage 702 includes burrs 604. In the section representing the second stage 704, most burrs have been removed, leaving any remaining burrs 708. The air nozzle blows a gas to remove these remaining burrs 708 from the edge 602 and sweep them toward the vacuum side. The section representing the third stage 706 shows a smooth surface 710 resulting from the cleaning laser and air nozzle.

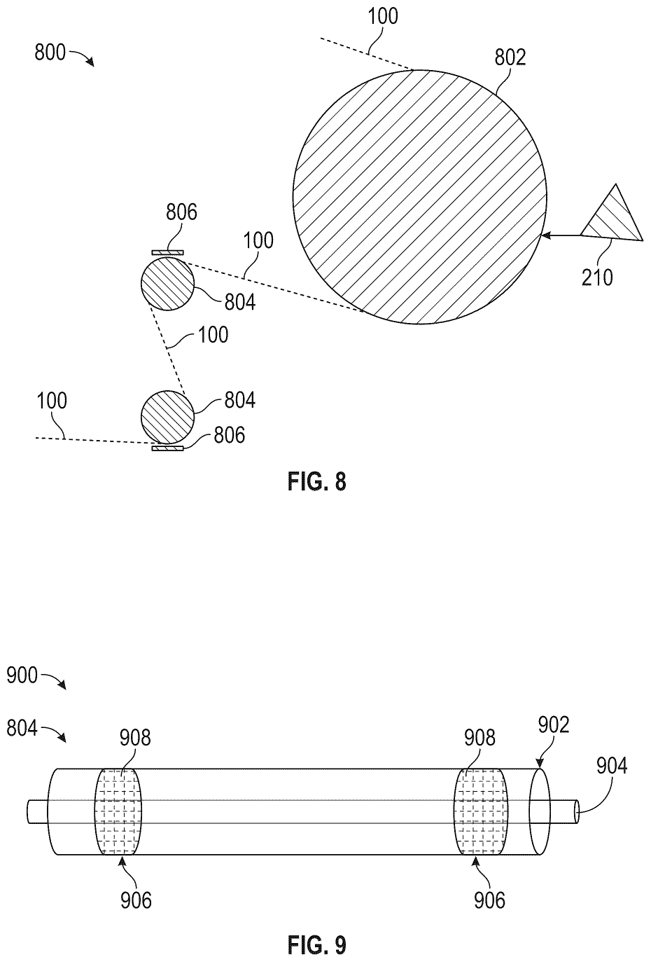

FIG. 8 shows a burr removal system 800 that can be used to perform the cleaning procedure disclosed herein, in another embodiment. The burr removal system 800 is a roller system that includes a first roller 802 and a second roller 804. The first roller 802 can be used to roll the electrode 100 past a cleaning laser 210 and the second roller 804 can be one or more vacuum rollers. The electrode 100 is rolled over the first roller 802 where the cleaning laser 210 is directed at the edge 106 of the electrode for cleaning. The electrode 100 then proceeds to roll over an outer surface of the second roller 804. The second roller 804 pulls remaining burrs from the electrode 100 via a vacuum created in the center of the second roller. Each second roller 804 includes a tab locator 806 to maintain the edge of the electrode at a selected location along the vacuum roller.

FIG. 9 shows a side view 900 of a vacuum roller 804, in one embodiment. The vacuum roller includes a cylindrical surface 902 that rotates about a central axis 904. The cylindrical surface 902 has a vacuum section 906 at a selected axial location along the surface. The vacuum section 906 includes holes 908 in the cylindrical surface. When the electrode passes over the second roller 804, the edge of the electrode is located at the vacuum section 906. A vacuum is created along the central axis 904 that pulls burrs and other artifacts radially inward from the edge of the electrode and through the vacuum section 906.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of manufacturing an electrode of a battery cell, comprising:
radiating an edge of the electrode including an artifact at a selected location with a cleaning laser to radiate the artifact with a beam of light, wherein a first support structure supports the electrode within a first chamber and a second support structure supports the cleaning laser;
creating a relative movement between the electrode and the cleaning laser via the first support structure and the second support structure to align the selected location with a nozzle located at a distance from the cleaning laser;
blowing a first stream of gas across a first surface of the electrode from the nozzle to remove the artifact from the edge; and
receiving the artifact in a second chamber via a vacuum between the first chamber and the second chamber.

2. The method of claim 1, wherein the second support structure includes the cleaning laser and a bristled device and the nozzle includes a plurality of nozzles that are spaced apart along the electrode in a direction of a first path, further comprising moving the cleaning laser and the bristled device along the first path while maintaining the electrode and the plurality of nozzles in a stationary position.

3. The method of claim 1, wherein the second support structure includes the cleaning laser and the nozzle, further comprising moving the cleaning laser and the nozzle while maintaining the electrode in a stationary position.

4. The method of claim 3, wherein the second support structure further includes a bristled device.

5. The method of claim 1, further comprising moving the electrode via the first support structure, wherein the second support structure is held in a stationary position and includes the cleaning laser, a bristled device and the nozzle.

6. The method of claim 1, wherein the nozzle further comprises a first nozzle directed along the first surface of the electrode and a second nozzle directed along a second surface of the electrode opposite the first surface.

7. The method of claim 1, further comprising one of: (i) blowing the first stream from the nozzle parallel to the first surface; (ii) blowing the first stream from the nozzle at an angle of less than 10 degrees to the first surface; (iii) blowing the first stream from the nozzle at an angle between 0 degrees and 45 degrees to the first surface; (iv) directing a flow of the gas due to the vacuum parallel to the first surface of the electrode; and (v) directing the flow of the gas due to the vacuum perpendicular to the first surface of the electrode.

8. The method of claim 1, further comprising creating a vacuum using a plurality of vacuum devices and controlling a balance of pressure between at least two of the plurality of vacuum devices using a check valve.

9. A system for manufacturing an electrode, comprising:
a first chamber;
a second chamber, wherein the second chamber creates a vacuum;
a baffle separating the first chamber from the second chamber, the baffle including a slit;
a first support structure that maintains the electrode at the slit, wherein the electrode includes an edge having an artifact;
a cleaning laser configured to radiate at the edge of the electrode to remove the artifact from the edge of the electrode;
a second support structure that supports the cleaning laser, wherein the first support structure and the second support structure generate a relative movement between the electrode and the cleaning laser; and
a nozzle directed at a first surface of the electrode for blowing a first stream of gas across the electrode to remove the artifact from the electrode, wherein the artifact is removed to the second chamber via the vacuum.

10. The system of claim 9, wherein the second support structure includes the cleaning laser and a bristled device and is configured to move the cleaning laser and the bristled device along a first path and the nozzle includes a plurality of nozzles spaced apart along the electrode in a direction of the first path and the electrode and the plurality of nozzles are held in a stationary position.

11. The system of claim 9, wherein the second support structure includes the cleaning laser and the nozzle and is configured to move the cleaning laser and the nozzle while the electrode is held in a stationary position.

12. The system of claim 11, wherein the second support structure further includes a bristled device.

13. The system of claim 9, wherein the first support structure is configured to move the electrode and the second support structure is configured to maintain the cleaning laser, a bristled device and the nozzle in a stationary position.

14. The system of claim 9, wherein the nozzle further comprises a first nozzle directed along the first surface of the electrode and a second nozzle directed along a second surface of the electrode opposite the first surface.

15. The system of claim 9, wherein one of: (i) the nozzle is configured to blow the first stream parallel to the first surface; (ii) the nozzle is configured to blow the first stream at an angle of less than 10 degrees to the first surface; (iii) the nozzle is configured to blow the first stream at an angle between 0 degrees and 45 degrees to the first surface; (iv) the vacuum directs a flow of the gas parallel to the first surface of the electrode; and (v) the vacuum directs the flow of the gas due to the vacuum perpendicular to the first surface of the electrode.

16. The system of claim 9, further comprising a plurality of vacuum devices for creating the vacuum and a check valve for controlling a balance of pressure between at least two of the plurality of vacuum devices.

17. A method of manufacturing an electrode, comprising:
rolling the electrode over a first roller and a second roller;
cleaning an artifact from edge of the electrode using a cleaning laser directed at the electrode at the first roller; and
vacuuming the edge of the electrode at the second roller to remove the artifact from the edge of the electrode.

18. The method of claim 17, further comprising vacuuming the artifact using vacuum directed radially inward at the second roller.

19. The method of claim 17, wherein the second roller includes a vacuum section, further comprising rolling the electrode over the second roller to place the edge at the vacuum section.

20. The method of claim 19, further comprising controlling a location of the electrode at the second roller via a tab locator.
